(19) United States
(12) Patent Application Publication
(10) Pub. No.: US 2017/0057133 A1
(43) Pub. Date: Mar. 2, 2017

(54) METHOD FOR INJECTION MOLDING USING REDUCED MELT TEMPERATURES

(71) Applicant: IMFLUX INC, Hamilton, OH (US)

(72) Inventors: H. Kenneth Hanson, III, Hamilton, OH (US); Gene Michael Altonen, Hamilton, OH (US)

(21) Appl. No.: 15/247,482

(22) Filed: Aug. 25, 2016

Related U.S. Application Data
(60) Provisional application No. 62/210,525, filed on Aug. 27, 2015.

(51) Int. Cl. B29C 45/00; B29C 45/78; B29C 45/77; B29C 45/73

(52) U.S. Cl. CPC B29C 45/0001; B29C 45/73; B29C 45/78; B29C 45/77; B29C 2945/76006; B29C 2945/7604; B29C 2945/76498; B29K 2105/0067

(57) ABSTRACT

A molded article is formed using an injection molding apparatus by heating a thermoplastic material to a melt temperature, injecting the heated thermoplastic material into at least one mold cavity of an injection molding apparatus at a substantially constant pressure, and cooling the thermoplastic material to an ejection temperature. The thermoplastic material is heated to a reduced melt temperature which is less than a minimum conventional melt temperature.

### CROSS-REFERENCE TO RELATED APPLICATIONS

This application is a non-provisional and claims the benefit of the filing date of U.S. Provisional Application No. 62/210,525, filed Aug. 27, 2015. The priority application, U.S. 62/210,525, is hereby incorporated by reference.

### FIELD OF THE DISCLOSURE

This application relates generally to injection molding and, more specifically, to approaches for injection molding parts at lower melt temperatures, which can reduce the energy required to form a molded article.

### BACKGROUND

Injection molding is a technology commonly used for high-volume manufacturing of parts constructed of thermoplastic materials. During repetitive injection molding processes, a thermoplastic resin, typically in the form of small pellets or beads, is introduced into an injection molding machine which melts the pellets under heat and pressure. The molten material is then forcefully injected into a mold cavity having a particular desired cavity shape. The injected plastic is held under pressure in the mold cavity and subsequently is cooled and removed as a solidified part having a shape closely resembling the cavity shape of the mold. A single mold may have any number of individual cavities.

Conventional injection molding processes utilize variable and high pressure during injection of the molten material into the mold cavity. With conventional processing, it is generally considered advantageous to utilize high melt temperatures to render the material viscous and therefore easier to inject into the mold cavity. While increasing the pressure can allow the molding machine to continue to force molten material into the mold before the flow path has closed off, without a sufficiently fluid thermoplastic material, the pressure required to force the molten material into the mold can be at levels that are potentially damaging to the machine and its useful life or even be beyond the capabilities of the machine. Additionally, it is generally understood in the art that use of higher melt temperatures reduces defects in the molding process including short shot, freeze-off, and mold-in stress in the molded article. In accordance with this understanding in the art, manufacturers of thermoplastic materials for injection molding provide a range of melt temperatures suitable for injection molding that are significantly higher than the glass transition temperature of the material. High melt temperatures are often accompanied by high mold cavity temperature to facilitate flow of the molten material through the entire mold and to produce quality parts that are free of internal as well as surface defects.

### SUMMARY

In accordance with an embodiment of the disclosure, a method for forming a molded article using an injection molding apparatus can include heating a thermoplastic material to a reduced melt temperature, which is below the minimum conventional melt thermoplastic material, injecting the heated thermoplastic material into at least one mold cavity of an injection molding apparatus using a substantially constant pressure, and cooling the thermoplastic material to an ejection temperature. In accordance with an embodiment, the reduced melt temperature is at least 5° C. below the minimum conventional melt temperature of the thermoplastic material. In various embodiments, the reduced melt temperature can be at least 20° C. below the minimum conventional melt temperature.

In accordance with an embodiment of the disclosure, a method of forming a molded article using an injection molding apparatus can include heating a thermoplastic material to a reduced melt temperature; injecting the heated thermoplastic material into at least one mold cavity of an injection molding apparatus, wherein the at least one mold cavity is filled at a substantially constant pressure; and cooling the thermoplastic material in the at least one mold cavity to an ejection temperature to form the molded article. The thermoplastic material can be acrylonitrile butadiene styrene (ABS), the reduced melt temperature is about 5° C. to about 30° C. less than a minimum conventional melt temperature of the ABS and an energy required to form the molded article is at least about 3% less than an energy required to form the molded article using a conventional injection molding process at the minimum conventional melt temperature. The thermoplastic material can be nylon 6 and the reduced melt temperature is about 5° C. to about 30° C. less than a minimum conventional melt temperature of the nylon 6, and an energy required to form the molded article is at least about 3% less than an energy required to form the molded article using a conventional injection molding process at the minimum conventional melt temperature. The thermoplastic material can be polycarbonate (PC) and the reduced melt temperature is about 5° C. to about 50° C. less than a minimum conventional melt temperature of the PC, and an energy required to form the molded article is at least about 3% less than an energy required to form the molded article using a conventional injection molding process at the minimum conventional melt temperature. The thermoplastic material can be high density polyethylene (HDPE) and the reduced melt temperature is about 5° C. to about 45° C. less than a minimum conventional melt temperature of the HDPE, and an energy required to form the molded article is at least about 3% less than an energy required to form the molded article using a conventional injection molding process at the minimum conventional melt temperature. The thermoplastic material can be polyethylene terephthalate (PET) and the reduced melt temperature is about 5° C. to about 20° C. less than a minimum conventional melt temperature of the PET, and an energy required to form the molded article is at least about 3% less than an energy required to form the molded article using a conventional injection molding process at the minimum conventional melt temperature. The thermoplastic material can be polypropylene (PP) and the reduced melt temperature is about 5° C. to about 45° C. less than a minimum conventional melt temperature of the PP, and an energy required to form the molded article is at least about 3% less than an energy required to form the molded article using a conventional injection molding process at the minimum conventional melt temperature. The thermoplastic material can be polystyrene (PS) and the reduced melt temperature is about 5° C. to about 35° C. less than a minimum conventional melt temperature of the PS, and an energy required to form the molded article is at least about 3% less than an energy required to form the molded article using a conventional injection molding process at the minimum conventional melt temperature. The thermoplastic material can be poly(methyl methacrylate) (PMMA) and the reduced melt temperature is about 5° C. to about 40° C. less than a minimum conventional melt temperature of the PMMA, and an energy required to form the molded article is at least about 3% less than an energy required to form the molded article using a conventional injection molding process at the minimum conventional melt temperature.

In accordance with another embodiment, a method of forming a molded article using an injection molding apparatus can include heating a thermoplastic material to a reduced melt temperature; injecting the heated thermoplastic material into at least one mold cavity of an injection molding apparatus, wherein the at least one mold cavity is filled at a substantially constant pressure; and cooling the thermoplastic material in the at least one mold cavity to an ejection temperature to form the molded article. In various aspects of this embodiment, the thermoplastic material is an acrylonitrile butadiene styrene (ABS) having a minimum conventional melt temperature of about 216° C., and the reduced melt temperature is about 185° C. to about 211° C., or the thermoplastic material is a nylon 6 having a minimum conventional melt temperature of about 253° C. and the reduced melt temperature is about 220° C. to about 248° C., or the thermoplastic material is a polycarbonate (PC) having a minimum conventional melt temperature of about 292° C. and the reduced melt temperature is about 240° C. to about 287° C., or the thermoplastic material is a high density polyethylene (HDPE) having a minimum conventional melt temperature of about 216° C. and the reduced melt temperature is about 170° C. to about 211° C., or the thermoplastic material is a polyethylene terephthalate (PET) having a minimum conventional melt temperature of about 250° C. and the reduced melt temperature is about 230° C. to about 245° C., or the thermoplastic material is a polypropylene (PP) having a minimum conventional melt temperature of about 212° C. and the reduced melt temperature is about 162° C. to about 207° C., or the thermoplastic material is a polystyrene (PS) having a minimum conventional melt temperature of about 185° C. and the reduced melt temperature is about 150° C. to about 180° C., or the thermoplastic material is a poly(methyl methacrylate) (PMMA) having a minimum conventional melt temperature of about 227° C. and the reduced melt temperature is about 187° C. to about 222° C.

In yet another embodiment of the disclosure, method of forming a molded article using an injection molding apparatus, can include heating a thermoplastic material to a reduced melt temperature, wherein the reduced melt temperature is at least 5° C. less than a minimum conventional melt temperature of the thermoplastic material; injecting the heated thermoplastic material into at least one mold cavity of an injection molding apparatus, wherein the at least one mold cavity is filled at a substantially constant pressure; and cooling the thermoplastic material in the at least one mold cavity to an ejection temperature to form the molded article. In various aspects of the embodiment, the thermoplastic material is acrylonitrile butadiene styrene (ABS) and the molded article is formed at a power index of about 1.02 to about 1.16 when compared to forming the molded article using a conventional injection molding process at the minimum conventional melt temperature, or the thermoplastic material is nylon 6 and the molded article is formed at a power index of about 1.02 to about 1.22 when compared to forming the molded article using a conventional injection molding process at the minimum conventional melt temperature, or the thermoplastic material is polycarbonate (PC) and the molded article is formed at a power index of about 1.02 to about 1.23 when compared to forming the molded article using a conventional injection molding process at the minimum conventional melt temperature, or the thermoplastic material is high density polyethylene (HDPE) and the molded article is formed at a power index of about 1.02 to about 1.23when compared to forming the molded article using a conventional injection molding process at the minimum conventional melt temperature, or the thermoplastic material is polyethylene terephthalate (PET) and the molded article is formed at a power index of about 1.02 to about 1.10 when compared to forming the molded article using a conventional injection molding process at the minimum conventional melt temperature, or the thermoplastic material is polypropylene (PP) and the molded article is formed at a power index of about 1.02 to about 1.30 when compared to forming the molded article using a conventional injection molding process at the minimum conventional melt temperature, or the thermoplastic material is polystyrene (PS) and the molded article is formed at a power index of about 1.02 to about 1.17 when compared to forming the molded article using a conventional injection molding process at the minimum conventional melt temperature, or the thermoplastic material is poly(methyl methacrylate) (PMMA) the molded article is formed at a power index of about 1.02 to about 1.23 when compared to forming the molded article using a conventional injection molding process at the minimum conventional melt temperature.

In various embodiments, the method results in a molded article that is free of short shot and/or freeze-off. Further, the molded article may be formed to meet any number of required standards to be deemed a quality part. In various embodiments, the thermoplastic material may be substantially free of rheology modifying additives, however, it is understood that in some embodiments, any number of additives may be used to modify characteristics of the thermoplastic and/or the molded part.

### BRIEF DESCRIPTION OF THE DRAWINGS

FIG. 1 illustrates a schematic view of a low melt temperature injection molding machine constructed in accordance with various embodiments of the disclosure;

FIG. 2 is a schematic illustration of an injection molding cycle that may be carried out at low melt temperatures in accordance with various embodiments of the disclosure;

FIG. 3 illustrates a graph comparing the C/I Power Index verses a change (reduction) of the melt temperature for processing in a method of the disclosure; and

FIG. 4 illustrates a graph comparing the flow front velocity verses pressure for a method in accordance with the disclosure using reduced melt temperature as compared to a conventional process at conventional (higher) melt temperature.

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

### DETAILED DESCRIPTION

The present disclosure generally relate to systems, machines, products, and methods for producing products by injection molding and more specifically to systems, machines, products, and methods for injection molding parts at lower temperatures to reduce energy consumption expended during the injection molding process.

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates or runners, whether integral with a mold cavity or not, and support plates. Generally, average hardness refers to the volume weighted hardness of material in the mold cooling region.

The term “average thermal conductivity” is defined as the thermal conductivity of any materials that make up the mold cavity or the mold side or mold part. Materials that make up coatings, stack plates, support plates, and gates or runners, whether integral with the mold cavity or separate from the mold cavity, are not included in the average thermal conductivity. Average thermal conductivity is calculated on a volume weighted basis.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “C/I Index” or ratio as used herein is the ratio of power consumed during a conventional injection molding process using a conventional melt temperature (“C”) to power consumed during injection molding process in accordance with embodiment of the disclosure at a reduced melt temperature (“I”). In other words, the C/I index represents the theoretical cooling power savings achieved by molding a part by a method in accordance with the present disclosure as compared to conventional methods and temperatures. A person of ordinary skill in the art would recognize that a power savings of 2% (i.e., a C/I index value of 1.02) or more represents a significant savings in the art. Such a power savings can allow for increased number of molder parts without an increase in power consumption as compared to a conventional injection molding process, and/or reduction in the number of molding machines needed to generate the same number of parts. Such energy savings can result in significant cost savings, for example on the order of hundreds of thousands of dollars.

The C/I index is calculated using Equation 1:

$$\frac{( {m}_{part} * [ c ] * ( {T}_{Mc} - {T}_{E} ) ) / {t}_{cool}}{( {m}_{part} * [ c ] * ( {T}_{Mr} - {T}_{E} ) ) / {t}_{cool}}$$

wherein mₚₐᵣₜ is the mass of the molded article, [c] is the specific heat of the thermoplastic material, T_{Mc} is the conventional melt temperature, T_{E} is the ejection temperature, T_{Mr} is the reduced melt temperature, and t_{cool} is the theoretical time to cool the part from the melt temperature to the ejection temperature.

The term “conventional injection molding process” as used herein means a process whereby melt pressures are rapidly increased to over 15,000 psi and held at a relatively high pressure for a first period of time required to allow the molten material to flow into the mold cavity. The pressure is then decreased and held at a lower pack pressure to allow the material to pack into the cavity to ensure gaps are back filled. As a result, materials in various stages of solidification are packed upon one another, which may cause inconsistencies in the finished product such as stresses, sink, and non-optimal optical properties. Conventional injection molding processes utilize conventional melt temperatures, which are provided by the manufacturer of a thermoplastic material and selected to provide a readily flowable molten material that can be injected at pressures within the operating range of the injection molding equipment and produce quality parts that are generally free of defects, such as internal stress and surface defects.

The term “cycle time” is defined as a single iteration of an injection molding process that is required to fully form an injection molded part. Cycle time includes the steps of advancing molten thermoplastic material into a mold cavity, substantially filling the mold cavity with thermoplastic material, cooling the thermoplastic material, separating first and second mold sides to expose the cooled thermoplastic material, removing the thermoplastic material, and closing the first and second mold sides. This process is known in the art as a “fill, pack, and hold” cycle.

The term deflection temperature under load (DTUL) generally refers to the temperature at which a polymer deforms under a specified load. DTUL can be determined for a given specimen using ASTM D648 Plastic Test Standard. In various embodiments, the method can include cooling the molten material in the mold cavity to a temperature below the DTUL prior to ejecting the molded article from the mold cavity.

The term “effective cooling surface” is defined as a surface through which heat is removed from a mold part. One example of an effective cooling surface is a surface that defines a channel for cooling fluid from an active cooling system. Another example of an effective cooling surface is an outer surface of a mold part through which heat dissipates to the atmosphere. A mold part may have more than one effective cooling surface and thus may have a unique average thermal conductivity between the mold cavity surface and each effective cooling surface.

The terms “filled” and “full,” when used with respect to a mold cavity including thermoplastic material, are interchangeable and both terms mean that at least 70%, at least 72%, at least 74%, at least 76, at least 78%, at least 80%, at least 82%, at least 84%, at least 86%, at least 88%, at least 90%, at least 92%, at least 94%, at least 96%, at least 98%, or at least 99% of the mold cavity is filled with the molten thermoplastic material. For example, substantially the entire mold cavity is filled when about 70% to about 100%, about 75% to about 95%, about 80% to about 90%, or about 90% to about 100% of the mold cavity is filled with the molten thermoplastic material. The percentage of the mold cavity filled with the shot of molten thermoplastic material can be determined, for example, by placing a pressure transducer in the mold cavity at the end of fill point of the mold cavity corresponding to the desired fill percentage. The pressure transducer alerts the operator when the shot of molten thermoplastic material has reached the desired fill percentage.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “hesitation” generally refers to the point at which the velocity of the flow front is minimized sufficiently to allow a portion of the polymer to drop below its no flow temperature and begin to freeze off.

The term “low constant pressure injection molding machine” is defined as a class 101 or a class 30 injection molding machine that uses a substantially constant injection pressure that is less than 6000 psi. Alternatively, the term “low constant pressure injection molding machine” may be defined as an injection molding machine that uses a substantially constant injection pressure that is less than 6000 psi and that is capable of performing more than 1 million cycles, preferably more than 1.25 million cycles, more preferably more than 2 million cycles, more preferably more than 5 million cycles, and even more preferably more than 10 million cycles before the mold core (which is made up of first and second mold parts that define a mold cavity therebetween) reaches the end of its useful life. Characteristics of “low constant pressure injection molding machines” include mold cavities having an L/T ratio of greater than 100 (and preferably greater than 200), multiple mold cavities (preferably 4 mold cavities, more preferably 16 mold cavities, more preferably 32 mold cavities, more preferably 64 mold cavities, more preferably 128 mold cavities and more preferably 256 mold cavities, or any number of mold cavities between 4 and 512), a heated runner, and a guided ejection mechanism.

The term “low pressure” as used herein with respect to melt pressure of a thermoplastic material, means melt pressures in a vicinity of a nozzle of an injection molding machine of 6000 psi and lower.

As used herein, “commodity thermoplastic materials” or “commodity-grade thermoplastic material,” has conventional meaning and generally refers to standard grade thermoplastic materials that are most commonly used plastic productions, including in injection molding. Commodity thermoplastics often represent an inexpensive grade of the thermoplastic material. Commodity thermoplastic materials typically are substantially free of additives, particularly free of additives that affect the viscosity or melt temperature of the material.

As used herein, “conventional melt temperature” refers to the melt temperature or range of melt temperatures reported by the material supplier for processing the thermoplastic material for use in conventional injection molding processes. A manufacturer may provide a minimum conventional melt temperature, representing the minimum temperature at which the material should be process in an injection molding process. Alternatively, a manufacturer may provide an average conventional melt temperature. In order to ensure production of a quality part with a conventional injection molding process, the skilled person would not use a melt temperature that is more than 20° C. less than the average conventional melt temperature reported for a given thermoplastic material and expect a quality part to be produced. Accordingly, as used herein, the term “minimum conventional melt temperature” refers to a minimum melt temperature reported by the manufacturer or where no minimum value is reported, 20° C. less than the average melt temperature reported by the manufacturer. The conventional melt temperature may vary within a class of thermoplastic materials (e.g., ABS) based on the grade, purity, additives, molecular weight, and other parameters of the particularly supplied thermoplastic material. It is generally understood in the art of injection molding, that processing of the material at the conventional melt temperature or higher is needed in order to product a quality molded article. The skilled person will understand that the material supplier will report for each particular thermoplastic material a conventional melt temperature or range. For example, the material supplier may offer specialty materials within a given thermoplastic class (e.g., ABS), which may have, for example, a reduced conventional melt temperature as compared to a commodity grade of the thermoplastic material, due to the addition of additives of modification of the thermoplastic material to have a particular molecular weight. The skilled person will further understand that for each specialty or commodity grade of the thermoplastic material a defined conventional melt temperature or melt temperature range will be provided by the manufacturer. Table 1 below lists the average recommended conventional melt temperature and minimum conventional melt temperature for commodity-grade thermoplastic materials having a grade that is considered a commodity grade. That is, the reported values below are for the listed class of thermoplastic materials that have average molecular weights and are generally free of viscosity additives or other additives that may affect the melt temperature.

TABLE 1

| | Average | Minimum |
|---|---|---|
| | Conventional Melt | Conventional Melt |
| Commodity Material | Temperature (° C.) | Temperature |
| Acrylonitrile butadiene | 240 | 216 |
| styrene (ABS) | | |
| Nylon 6 | 265 | 253 |
| Polycarbonate (PC) | 290 | 292 |
| High Density Polyethylene | 245 | 216 |
| (HDPE) | | |
| Polyethylene terephthalate | 285 | 250 |
| (PET) | | |
| Polypropylene (PP) | 220 | 212 |
| Polystyrene (PS) | 200 | 185 |
| Poly(methyl methacrylate) | 240 | 227 |
| (PMMA) | | |

The term “melt holder”, as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit, and can be controlled to advance a diaphragm to force molten plastic through the machine nozzle. The molten material then flows through the runner system in to the mold cavity. The melt holder may be cylindrical in cross section, or have alternative cross sections that will permit a diaphragm to force polymer under pressures that can range from as low as 100 psi to pressures 40,000 psi or higher through the machine nozzle. The diaphragm may optionally be integrally connected to a reciprocating screw with flights designed to plasticize polymer material prior to injection.

The term “melt temperature” generally refers to the temperature of the thermoplastic material that is maintained in the melt holder, and in the material feed system when a hot runner system is used, which keeps the thermoplastic material in a molten state for injection of the thermoplastic material into the mold cavity.

The term “peak flow rate” generally refers to the maximum volumetric flow rate, as measured at the machine nozzle.

The term “Peak Power Flow Factor” refers to a normalized measure of peak power required by an injection molding system during a single injection molding cycle and the Peak Power Flow Factor may be used to directly compare power requirements of different injection molding systems. The Peak Power Flow Factor is calculated by first determining the Peak Power, which corresponds to the maximum product of molding pressure multiplied by flow rate during the filling cycle (as defined herein), and then determining the Shot Size for the mold cavities to be filled. The Peak Power Flow Factor is then calculated by dividing the Peak Power by the Shot Size.

As used herein, the term “quality molded article” refers to a molded article that satisfies one or more predetermined dimensional, performance, and/or aesthetic requirements within a defined tolerance range and is generally free of defects. Such dimensional requirements can include, but are not limited to, part lengths, widths, path lengths or perimeters, thickness, eccentricity, flatness or warp, parallelism, perpendicularity, and/or concentricity. Such performance requirements can include, but are not limited to, surviving and/or absorbing loads, such as tensile loads, compressive loads, torsional loads; exposure to vibration, surviving and/or absorbing electrical loads, and withstanding environmental exposures for a rated period of time. Additional performance requirements may include acoustic properties, such as, resonant frequencies, harmonics, and dampening behavior; and optical performance, such as percent transmission, dispersion, specularity, reflectance, and allowable aberrations,. Aesthetic requirements can include, but are not limited to color, texture, surface texture, knit lines, blush, gap trap vestiges, markings, such as burn markings or freedom from undesired markings, and visible sink. Quality parts are also substantially free of defects, including, but not limited to lacking internal voids or containing only internal voids that do not compromise mechanical, electrical, or optical performance, substantially free of mold-in stress or have mold-in stress within a given tolerance, and substantially free of defects resulting from short shot or freeze-off during the molding process, or flash beyond an acceptable level provided for in a quality specification for the molded article. Other requirements or part specification specified by a part customer are also within the contemplation of this definition. For example, the customer may require the molded article to have a given tensile and/or flexural moduli, impact resistance, hardness, chemical resistance and/or compatibility, abrasion resistance, thermal conductivity and/or resistivity, electrical conductivity and/or resistivity, reflectivity, specularity, clarity, percent transmission, index of refraction, and/or coefficient of friction.

The term “ram rate” generally refers to the linear speed the injection ram travels in the process of forcing polymer into the feed system.

As used herein, the term “reduced melt temperature,” refers to the melt temperatures suitable for use in the methods of the disclosure, which are generally below the minimum conventional melt temperature. For example, the reduced melt temperature can be below the minimum conventional melt temperature by at least about 5° C., 10° C., 15° C., or 20° C. Other suitable values include about 5, 6, 7, 8, 9, 10, 11, 12, 13, 14, 15, 16, 20, 21, 22, 23, 24, 25, 26, 27, 28, 29, 30, 31, 32, 33, 34, 35, 36, 37, 38, 39, 40° C., and any range formed by a combination of these values. The extent of the reduction in the melt temperature will depend on the thermoplastic materials as discussed in detail below.

The term “shot size” generally refers to the volume of polymer to be injected from the melt holder to completely fill the mold cavity or cavities. The Shot Size volume is determined based on the temperature and pressure of the polymer in the melt holder just prior to injection. In other words, the shot size is a total volume of molten plastic material that is injected in a stroke of an injection molding ram at a given temperature and pressure. The shot of molten plastic material may be injected into one or more injection cavities through one or more gates. The shot of molten plastic material may also be prepared and injected by one or more melt holders.

The term “substantially constant pressure” as used herein with respect to a melt pressure of a thermoplastic material, means that deviations from a baseline melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of approximately 30% from a baseline melt pressure. For example, the term “a substantially constant pressure of approximately 4600 psi” includes pressure fluctuations within the range of about 6000 psi (30% above 4600 psi) to about 3200 psi (30% below 4600 psi). A melt pressure is considered substantially constant as long as the melt pressure fluctuates no more than 30% from the recited pressure.

The term “thermoplastic material” or “thermoplastic resin” or “polymer” as used herein refers to a material that becomes pliable or moldable above a specific temperature and solidifies upon cooling. Exemplary thermoplastic materials include, but are not limited to, acrylonitrile butadiene styrene (ABS), nylon, polycarbonate (PC), high density polyethylene (HDPE), polyethylene terephthalate (PET), polypropylene (PP), polystyrene (PS), and poly(methyl methacrylate) (PMMA).

The term “useful life” as used herein refers to the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being force ably closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “volumetric flow rate” generally refers to the flow rate as measured at the machine nozzle. This flow rate can be calculated based on the ram rate and ram cross sectional area, or measured with a suitable sensor located in the machine nozzle.

A method of forming an injection molded article can include heating a thermoplastic material to a desired melt temperature, injecting at a substantially constant pressure the molten thermoplastic material into at least one mold cavity to fill the mold cavity with the thermoplastic material, and cooling the thermoplastic material in the mold cavity to an ejection temperature. The method can include heating a predetermined amount (commonly referred to as a “shot”) of the thermoplastic material for injection. The predetermined amount or shot can vary depending on the mold cavity size and/or the number of mold cavities. The mold can include two (or more) portions, such as a mold core and a mold cavity plate, that are clamped together form the mold walls that define one or more mold cavities. All or portions of the mold can be heated during injection to a desired mold temperature. Further, all or portions of the mold can be cooled during cooling the molten material in the mold cavity to more quickly bring the molten material to the ejection temperature. The ejection temperature can vary depending on the thermoplastic material used to form the part. Generally, the thermoplastic material is cooled such that at least outside surfaces of the molded part are sufficiently solid so that the part will maintain its molded shape once ejected. Once the ejection temperature is reached, the molded part can be ejected from the mold cavity by opening of the mold portions. The portions can then be reclosed and clamped to begin another injection molding cycle.

In various embodiments, the method can utilize substantially constant low pressure. For example, a pressure of about 400 psi to less than 6000 psi can be used in a low constant pressure method. For example, substantially low constant pressure can be about 400 psi to about 5900 psi, about 500 psi to about 4500 psi, about 600 psi to about 4000 psi, about 700 psi, to about 3500 psi, about 800 psi to about 3000 psi, about 900 psi to about 2500 psi, or about 1000 psi to about 2000 psi. Other suitable values for processing at substantially low constant pressure can be about 400, 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800, 5000, 5200, 5400, 5600, 5800, and less than 6000 psi, and any range formed by a combination of these values. However, it is also contemplated herein that substantially constant pressures within any suitable range can be used. For example, pressures in a range of about 400 psi to about 35000 psi, about 1000 psi to about 34000 psi, about 2000 psi to about 30000 psi, about 4000 psi to about 25000 psi, about 5000 psi to about 10000 psi, about 6000 psi to about 8000 psi, about 6000 psi to about 35000 psi, and about 10000 psi to about 35000 psi can be used. Other suitable pressures for substantially constant pressure can be about 400, 500, 600, 700, 800, 900, 1000, 2000, 3000, 4000, 5000, 6000, 7000, 8000, 9000, 10000, 15000, 20000, 25000, 30000, 35000, and any range formed by a combination of these values. A method of injection molding using substantially constant pressure is disclosed in U.S. Patent Publication No. 2012/0328724, the disclosure of which is incorporated herein by reference in its entirety.

Constant pressure injection molding machines may also be high productivity injection molding machines (e.g., a class 101 or a class 30 injection molding machine, or an “ultra high productivity molding machine”), such as the high productivity injection molding machine disclosed in U.S. Pat. No. 8,828,219, which is hereby incorporated by reference herein, that may be used to produce thin-walled consumer products, such as toothbrush handles and razor handles. Thin walled parts are generally defined as having a high L/T ratio of 100 or more.

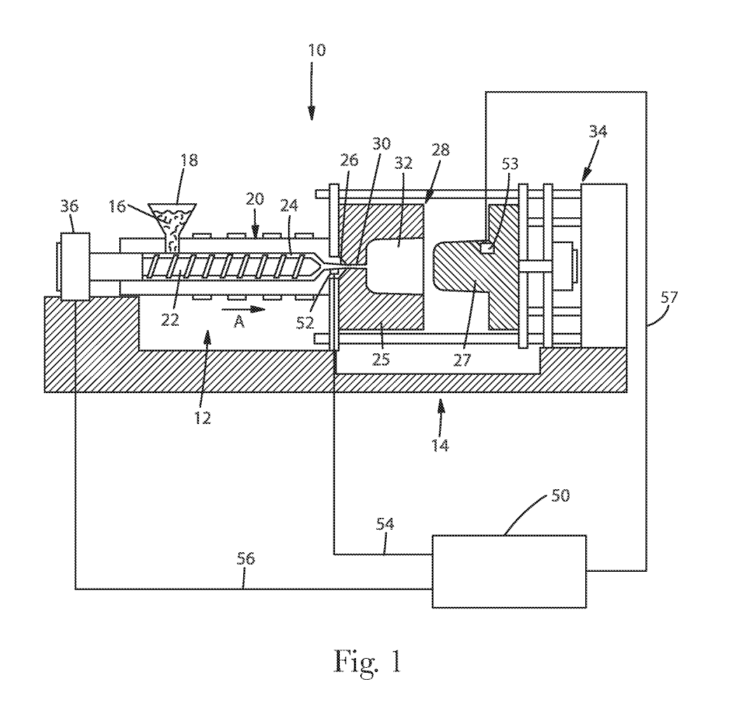

Referring to the figures in detail, FIG. 1 illustrates an exemplary constant pressure injection molding apparatus 10 that generally includes an injection system 12 and a clamping system 14. A thermoplastic material may be introduced to the injection system 12 in the form of thermoplastic pellets 16. The thermoplastic pellets 16 may be placed into a hopper 18, which feeds the thermoplastic pellets 16 into a heated barrel 20 of the injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to be heated to the melt temperature, forming a molten thermoplastic material 24.

The reciprocating screw 22 forces the molten thermoplastic material 24, toward a nozzle 26 to form a shot of thermoplastic material, which will be injected at substantially constant pressure into a mold cavity 32 of a mold 28 via one or more gates 30, preferably three or less gates, that direct the flow of the molten thermoplastic material 24 to the mold cavity 32. In other embodiments the nozzle 26 may be separated from one or more gates 30 by a feed system (not shown). The mold cavity 32 is formed between first and second mold sides 25, 27 of the mold 28 and the first and second mold sides 25, 27 are held together under pressure by a press or clamping unit 34. The press or clamping unit 34 applies a clamping force during the molding process that is greater than the force exerted by the injection pressure acting to separate the two mold halves 25, 27, thereby holding the first and second mold sides 25, 27 together while the molten thermoplastic material 24 is injected into the mold cavity 32. To support these clamping forces, the clamping system 14 may include a mold frame and a mold base.

Once the shot of molten thermoplastic material 24 is injected into the mold cavity 32, the reciprocating screw 22 stops traveling forward. The molten thermoplastic material 24 takes the form of the mold cavity 32 and the molten thermoplastic material 24 cools inside the mold 28 until the thermoplastic material 24 solidifies. Once the thermoplastic material 24 has solidified, the press 34 releases the first and second mold sides 25, 27, the first and second mold sides 25, 27 are separated from one another, and the finished part may be ejected from the mold 28. The mold 28 may include a plurality of mold cavities 32 to increase overall production rates. The shapes of the cavities of the plurality of mold cavities may be identical, similar or different from each other. (The latter may be considered a family of mold cavities).

A controller 50 is communicatively connected with a sensor 52, located in the vicinity of the nozzle 26, and a screw control 36. The controller 50 may include a microprocessor, a memory, and one or more communication links. The controller 50 may also be optionally connected to a sensor 53 located proximate an end of the mold cavity 32. This sensor 32 may provide an indication of when the thermoplastic material is approaching the end of fill in the mold cavity 32. Depending on geometry and flow conditions, the last place in the mold cavity to fill with thermoplastic material (i.e., the end of fill location) may not necessarily be the furthest location from the gate. The sensor 32 may sense the presence of thermoplastic material optically, pneumatically, mechanically or otherwise sensing pressure and/or temperature of the thermoplastic material. When pressure or temperature of the thermoplastic material is measured by the sensor 52, this sensor 52 may send a signal indicative of the pressure or the temperature to the controller 50 to provide a target pressure for the controller 50 to maintain in the mold cavity 32 (or in the nozzle 26) as the fill is completed. This signal may generally be used to control the molding process, such that variations in material viscosity, mold temperatures, melt temperatures, and other variations influencing filling rate, are adjusted by the controller 50. In some embodiments, the controller 50 may command the screw 22 to advance at a rate that maintains a substantially constant melt pressure in the nozzle 26.

These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52, and/or the sensor 53, and the screw control 36 via wired connections 54, 57, and 56, respectively. In other embodiments, the controller 50 may be connected to the sensors 52, 53 and screw control 56 via a wireless connection, a mechanical connection, a hydraulic connection, a pneumatic connection, or any other type of communication connection known to those having ordinary skill in the art that will allow the controller 50 to communicate with both the sensors 52, 53 and the screw control 36. The sensors 52, 53 may be any type of sensors adapted to sense a condition of the injection molding apparatus 10. For example, the sensors 52, 53 may be temperature sensors, pressure sensors, and the like. Other examples are possible.

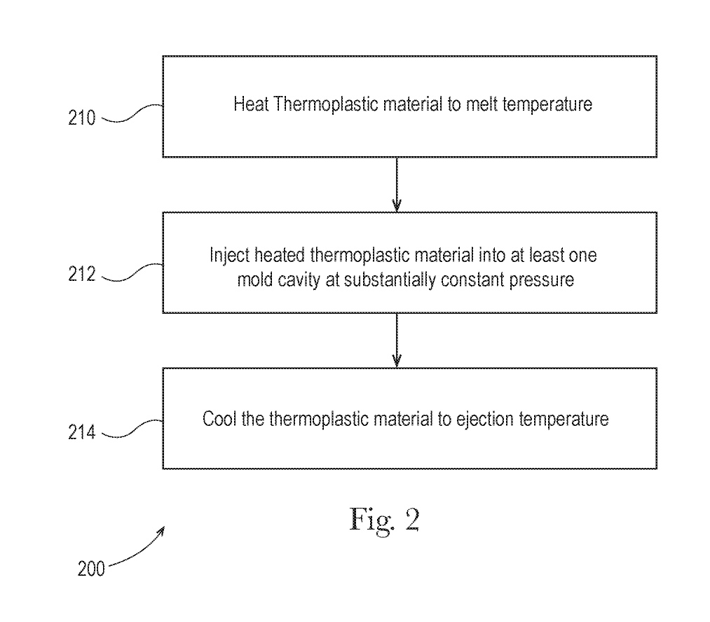

Turning to FIG. 2, a method 200 for forming a molded article using an injection molding apparatus is provided. At 210, thermoplastic material is heated to a melt temperature. At step 212, the heated thermoplastic material is injected into at least one mold cavity at a substantially constant pressure. At 214, the thermoplastic material is cooled to an ejection temperature. The method 200 may further include removing the thermoplastic material from the mold cavity using any number of conventional methods. The step 212 of injecting the heated thermoplastic material may occur at a substantially constant pressure as described above.

The step 214 of cooling the thermoplastic material to an ejection temperature is based on a theoretical cooling time for parts having a wall thickness of approximately 2 mm. It is understood that wall thicknesses of varying dimensions may be used in the approach 200. However, the desired wall thickness will have an effect on the overall cooling time of the material. In some examples, the ejection temperature is approximately equal to the DTUL. In some examples, the ejection temperature may be greater or less than the DTUL value.

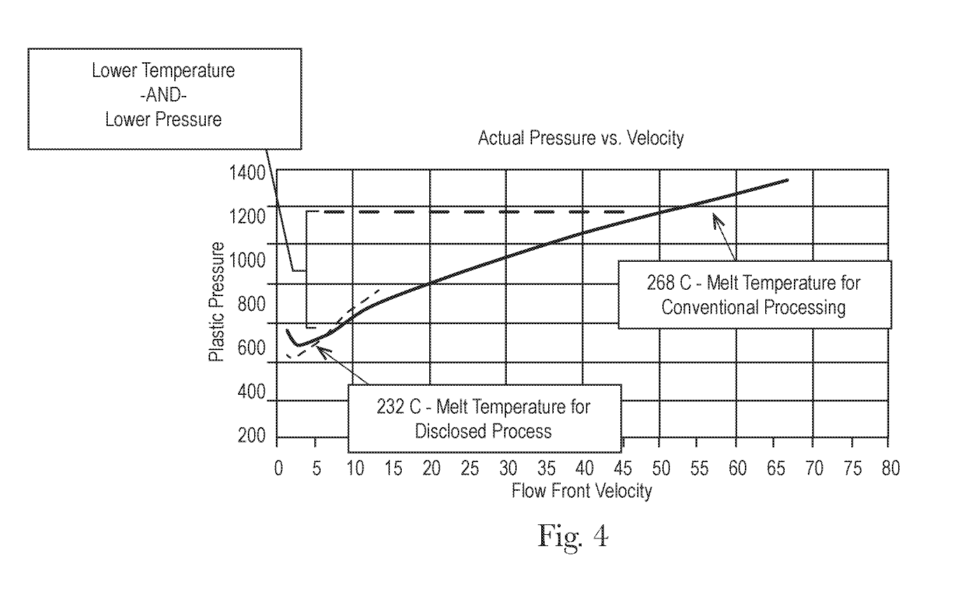

Contrary to the general understanding in the art, the injection molding processes disclosed herein can advantageously form a molded part using melt temperatures below the conventional melt temperature. The injection molding processes disclosed herein can allow for use of reduced temperatures without the need for significantly increased peak pressure, which is the highest melt pressure achieved during the injection molding cycle. In contrast, reduction of temperature using a conventional injection molding process requires increasing in the pressure used during injection of the molten material to force the less viscous thermoplastic material through the mold cavity. Such increase in pressure can put undue stress on the injection molding equipment, result in flash during injection, and even require pressures for injection beyond the capabilities of the equipment making it impossible to process at certain melt temperatures. Additionally, the higher pressures, when combined with a less fluid polymer, may not allow the material to easily relax into the molded shape, which may result in warpage, weak zones, poor welds and flow lines, and the like. Use of lower melt temperatures in conventional processing can also result in defects in the surface of the mold, rendering the molded article unsuitable. Without intending to be bound by theory, it is believed that when using the conventional injection molding process, lower than conventional melt temperatures do not heat the thermoplastic material to a sufficiently fluid state, and pressure required to force this less viscous, stiffer molten thermoplastic material through the mold cavity using the conventional process can result in shearing of the polymer chains, leading to defects in the molded article, including for example, surface defects as well as internal stress in the molded article. Even if the less viscous, stiffer molten thermoplastic material (heated to a lower than conventional melt temperature) could be successfully forced in to the mold, the time to fill the mold would be significantly increased making the process unsuited for commercial production and contrary to the directive in the art of minimizing the cycle time. Processing at lower temperatures using conventional processing can also prohibit the production of parts having fine features sharp edges and high l/t parts, as it is increasingly more (if not impossible) to fill such parts with the less viscous, stiffer shot. As illustrated in FIG. 4, the processes in accordance with embodiments of the disclosure, however, can allow for these reduced temperatures without significant or disadvantageous increase in injection pressure, increase in cycle time, or production of defective parts. FIG. 4 illustrates the significantly reduced pressures that can be used with the methods in accordance with disclosure despite the reduction in the melt temperature. The example shown in FIG. 4 is for a PET type material.

Reduction of the melt temperature can beneficially allow for a reduction in the amount of energy required to form the molded article by requiring less energy to heat the thermoplastic material as well as less energy to remove the heat from the thermoplastic material once filled in the cavity to reach the ejection temperature. Reduced melt temperature can also allow for reduced mold temperatures, as the mold does not need to be heated as much to maintain the higher melt temperatures used with conventional injection molding. This can beneficially reduce or avoid disfigurement of the molded article are used when removing the molded article from the mold using pickers or other tools, which can occur when removing molded articles from high temperature molds. Additionally or alternatively, this use of reduced melt temperatures can allow for reduced cycle time by reducing the amount of time required to heat the thermoplastic material and/or reduce the amount of time required to cool the material in the mold cavity to the ejection temperature. Lower overall processing temperatures may be achieved in addition to reduced cooling times, which can increase efficiency, reduce the overall carbon footprint, and lower operating and manufacturing costs. Further, in the processes of the disclosure various temperature-sensitive colorants and other additives may be added to the thermoplastic materials due to lower operating temperatures. Additionally, it may be possible with the process of the disclosure to utilize molds having a greater number of mold cavities without substantially increasing cycle time as compared to processing at conventional temperatures. Advantageously, utilizing lower melt temperature in the methods of the disclosure can still result in the forming of high quality molded articles, which meet all dimensional, mechanical, functional, and aesthetic requirements.

In accordance with an embodiment, the thermoplastic material can be acrylonitrile butadiene styrene (ABS). In various embodiments of the process of the disclosure, the melt temperature can be less than the minimum conventional melt temperature to about 30° C. less than the minimum conventional melt temperature. For example, the melt temperature can be about 5° C. to about 30° C., about 20° C. to about 30° C., about 10° C. to about 30° C., about 15° C. to about 30° C., about 20° C. to about 25° C., about 25° C. to about 30° C., about 22° C. to about 28° C., about 24° C. to about 28° C., about 20° C. to about 26° C., and about 26° C. to about 30° C. less than the minimum conventional melt temperature. Other suitable values below the minimum conventional melt temperature include, for example, about 5, 6, 7, 8, 9, 10, 11, 12, 13, 14, 15, 16, 17, 18, 19, 20, 21, 22, 23, 24, 25, 26, 27, 28, 29, 30° C., and any range formed by a combination of these values. For example, for a commodity grade ABS having a minimum conventional melt temperature of 216° C., the method of the disclosure can include processing the commodity grade ABS at a reduced melt temperature, for example, of about 185° C. to less than 216° C., about 185° C. to about 210° C., and about 185° C. to about 196° C. For example, the ABS having a minimum conventional melt temperature of 216° C. can be processed at a reduced melt temperature of about 185, 190, 195, 200, 210, 211, 212° C., and any range formed by a combination of these values.

In accordance with an embodiment, the thermoplastic material can be nylon-6. In various embodiments of the process of the disclosure, the melt temperature can be less than the minimum melt temperature to about 30° C. less than the minimum conventional melt temperature. For example, the melt temperature can be about 5° C. to about 30° C., about 20° C. to about 30° C., about 10° C. to about 30° C., about 15° C. to about 30° C., about 20° C. to about 25° C., about 25° C. to about 30° C., about 22° C. to about 28° C., about 24° C. to about 28° C., about 20° C. to about 26° C., and about 26° C. to about 30° C. less than the minimum conventional melt temperature. Other suitable values below the minimum conventional melt temperature include, for example, about 5, 6, 7, 8, 9, 10, 11, 12, 13, 14, 15, 16, 17, 18, 19, 20, 21, 22, 23, 24, 25, 26, 27, 28, 29, 30° C., and any range formed by a combination of these values. For example, a commodity grade nylon 6 having a minimum conventional melt temperature of 253° C., the method of the disclosure can include processing the commodity grade nylon 6 at a reduced melt temperature, for example, of about 220° C. to less than 253° C., about 220° C. to about 248° C., or about 220° C. to about 235° C. For example, the nylon 6 having a minimum conventional melt temperature of 253° C. can be processed at a reduced melt temperature of about 220, 225, 230, 235, 240, 245, 246, 247, 248° C., and any range formed by a combination of these values.

In accordance with another embodiment, the thermoplastic material can be polycarbonate (PC). In various embodiments of the process of the disclosure, the melt temperature can be less than the minimum conventional melt temperature to about 50° C. less than the minimum conventional melt temperature. For example, the melt temperature can be about 5° C. to about 50° C., about 10° C. to about 30° C., about 20° C. to about 50° C., about 25° C. to about 50° C., about 20° C. to about 45° C., about 25° C. to about 40° C., about 30° C. to about 40° C., about 25° C. to about 50° C., about 30° C. to about 50° C., and about 20° C. to about 35° C. less than the minimum conventional melt temperature. Other suitable values below the minimum conventional melt temperature include, for example, about 5, 6, 7, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50° C., and any range formed by a combination of these values. For example, for a commodity grade PC having a minimum conventional melt temperature of 292° C., the method of the disclosure can include processing commodity grade PC at a reduced melt temperature, for example, of about 242° C. to less than 292° C., about 242° C. to about 287° C., or about 242° C. to about 272° C. For example, the PC having a conventional minimum melt temperature of about 292° C. can be processes at a reduced melt temperature of about 242, 245, 250, 255, 260, 265, 270, 275, 280, 285, 287° C., and any range formed by a combination of these values.

In accordance with yet another embodiment, the thermoplastic material can be high density polyethylene (HDPE). In various embodiments of the process of the disclosure, the melt temperature can be less than the minimum conventional melt temperature to about 45° C. less than the minimum conventional melt temperature. For example, the melt temperature can be about 5° C. to about 45° C., about 10° C. to about 30° C., about 20° C. to about 45° C., about 15° C. to about 35° C., about 20° C. to about 40° C., about 25° C. to about 35° C., about 30° C. to about 45° C., about 25° C. to about 35° C., about 30° C. to about 45° C., and about 20° C. to about 35° C. less than the minimum conventional melt temperature. Other suitable values below the minimum conventional melt temperature include, for example, about 5, 6, 7, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45° C., and any range formed by a combination of these values. For example, for a commodity grade HDPE having a minimum conventional melt temperature of 216° C., the method of the disclosure can include processing commodity grade HDPE at a reduced melt temperature, for example, of about 171° C. to less than 216° C., about 171° C., to about 210° C., about 171° C. to about 196° C. For example, the HDPE having the minimum conventional melt temperature of 216° C. can be processes at a reduced melt temperature of about 171, 175, 180, 185, 190, 195, 200, 205, 210, 211° C., and any range formed by a combination of these values.

In accordance with an embodiment, the thermoplastic material can be polyethylene terephthalate (PET). In various embodiments of the process of the disclosure, the melt temperature can be less than the minimum melt temperature to about 20° C. less than the minimum conventional melt temperature. For example, the melt temperature can be about 5° C. to about 20° C., about 10° C. to about 20° C., about 15° C. to about 20° C., about 5° C. to about 15° C. less than the minimum melt temperature. Other suitable values below the minimum conventional melt temperature include, for example, about 5, 6, 7, 8, 9, 10, 11, 12, 13, 14, 15, 16, 17, 18, 19, 20° C., and any range formed by a combination of these values. For example, for a commodity grade PET having a minimum conventional melt temperature of 250° C., the method of the disclosure can include processing commodity grade PET at a reduced melt temperature of about 230° C. to less than 250° C., about 230° C. to about 240° C., about 230° C. to about 245° C. For example, the PET having a minimum conventional melt temperature of 250° C. can be processed at a reduced melt temperature of about 230, 232, 234, 235, 236, 238, 240, 242, 244, 245° C., and any range formed by a combination of these values.

In accordance with an embodiment, the thermoplastic material can be polypropylene (PP). In various embodiments of the process of the disclosure, the melt temperature can be less than the minimum conventional melt temperature to about 45° C. less than the minimum conventional melt temperature. For example, the melt temperature can be about 5° C. to about 45° C., about 10° C. to about 30° C., about 20° C. to about 45° C., about 15° C. to about 35° C., about 20° C. to about 40° C., about 25° C. to about 35° C., about 30° C. to about 45° C., about 25° C. to about 35° C., about 30° C. to about 45° C., and about 20° C. to about 35° C. less than the minimum conventional melt temperature. Other suitable values below the minimum conventional melt temperature include, for example, about 5, 6, 7, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45° C., and any range formed by a combination of these values. For example, for a commodity grade PP having a minimum conventional melt temperature of 212° C., the method of the disclosure can include processing commodity grade PP at a reduced melt temperature, for example, of about 162° C. to less than 212° C., about 162° C. to about 207° C., about 162° C. to 205° C., about 162° C. to about 192° C. For example, the PP having a minimum conventional melt temperature of 212° C. can be processed at a reduced melt temperature of about 162, 165, 170, 175, 180, 185, 190, 195, 200, 205, 206, 207° C., and any range formed by a combination of these values.

In accordance with another embodiment, the thermoplastic material can be polystyrene (PS). In various embodiments of the process of the disclosure, the melt temperature can be less than the minimum conventional melt temperature to about 35° C. less than the minimum conventional melt temperature. For example, the melt temperature can be about 5° C. to about 35° C., about 10° C. to about 30° C., about 15° C. to about 35° C., about 20° C. to about 35° C., about 20° C. to about 30° C., about 25° C. to about 35° C., about 30° C. to about 35° C., about 25° C. to about 35° C., about 22° C. to about 35° C., and about 20° C. to about 25° C. less than the minimum conventional melt temperature. Other suitable values below the minimum conventional melt temperature include, for example, about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35° C., and any range formed by a combination of these values. For example, for a commodity grade PS having a minimum conventional melt temperature of 185° C., the method of the disclosure can include processing commodity grade PS at a reduced melt temperature, for example, of about 150° C. to less than 185° C., about 150° C. to about 180° C., about 150° C. to about 165° C. For example, the PS having a minimum conventional melt temperature of 185° C. can be processed at a reduced melt temperature of about 150, 155, 160, 165, 170, 175, 180° C., and any range formed by a combination of these values.

In accordance with another embodiment, the thermoplastic material can be poly(methyl methacrylate) (PMMA). In various embodiments of the process of the disclosure, the melt temperature can be less than the minimum conventional melt temperature to about 40° C. less than the minimum conventional melt temperature. For example, the melt temperature can be about 5° C. to about 40° C., about 10° C. to about 30° C., about 20° C. to about 40° C., about 15° C. to about 35° C., about 20° C. to about 35° C., about 25° C. to about 35° C., about 30° C. to about 40° C., about 25° C. to about 35° C., about 25° C. to about 40° C., and about 20° C. to about 30° C. less than the minimum conventional melt temperature. Other suitable values below the minimum conventional melt temperature include, for example, about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40° C., and any range formed by a combination of these values. For example, for a commodity grade PMMA having an average reported minimum conventional melt temperature of 227° C., the method of the disclosure can include processing commodity grade PMMA at a reduced melt temperature, for example, of about 187° C. to less than 227° C., about 187° C. to about 222° C., about 180° C. to about 220° C., and about 187° C. to about 210° C. For example, the PMMA having a minimum conventional melt temperature of 227° C. can be processed at a reduced melt temperature of about 180, 185, 190, 195, 200, 205, 210, 215, 220, 222° C., and any range formed by a combination of these values.

As discussed above, the use of reduced melt temperatures can result in a reduction in the energy required to form the molded article. For example, in accordance with embodiments of the disclosure the method can result in a 10% to 35% reduction in the amount of energy required to form the molded article. The amount of energy (in kJ/kg) used to form a molded article is total energy required to heat thermoplastic material to the melt temperature and cool the thermoplastic material to the ejection temperature, which can be calculated using Equation 2:

((T_{M}−T_{RT})*[c])+((T_{M}−T_{E})*[c])

wherein T_{M} is the melt temperature, T_{RT} is room temperature, [c] is specific heat, and T_{E} is the ejection temperature.

For example, in embodiments in which the thermoplastic material is ABS, the method in accordance with the disclosure using a reduced melt temperature can result in an about 3% to about 20% reduction in energy as compared to forming the molded article using a conventional injection molding process at a conventional melt temperature. For example, the reduction in energy can be about 3 to about 18%, about 10% to about 20%, about 10% to about 15%, about 12% to about 20%, about 15% to about 20%, and about 12% to about 18%. Other suitable values include about 3, 4, 5, 6, 7, 8, 9, 10, 11, 12, 13, 14, 15, 16, 17, 18, 19, 20%, and any range formed by a combination of these values.

For example, in embodiments in which the thermoplastic material is nylon 6, the method in accordance with the disclosure using a reduced melt temperature can result in an about 3% to about 20% reduction in energy as compared to forming the molded article using a conventional injection molding process at a conventional melt temperature. For example, the reduction in energy can be about 3% to about 18%, about 10% to about 20%, about 10% to about 15%, about 12% to about 20%, about 15% to about 20%, and about 12% to about 18%. Other suitable values include about 3, 4, 5, 6, 7, 8, 9,10, 11, 12, 13, 14, 15, 16, 17, 18, 19, 20%, and any range formed by a combination of these values.

For example, in embodiments in which the thermoplastic material is PC, the method in accordance with the disclosure using a reduced melt temperature can result in an about 3% to about 25% reduction in energy as compared to forming the molded article using a conventional injection molding process at a conventional melt temperature. For example, the reduction in energy can be about 3% to about 20%, about 9% to about 25%, about 9% to about 15%, about 12% to about 20%, about 15% to about 25%, and about 10% to about 25%. Other suitable values include about 3, 4, 5, 6, 7, 8, 9, 10, 11, 12, 13, 14, 15, 16, 17, 18, 19, 20, 21, 22, 23, 24, 25%, and any range formed by a combination of these values.

For example, in embodiments in which the thermoplastic material is HDPE, the method in accordance with the disclosure using a reduced melt temperature can result in an about 3% to about 30% reduction in energy as compared to forming the molded article using a conventional injection molding process at a conventional melt temperature. For example, the reduction in energy can be about 3% to about 15%, about 10% to about 20%, about 10% to about 27%, about 3% to about 25%, about 10% to about 15%, about 12% to about 20%, about 15% to about 20%, about 11% to about 16%, and about 12% to about 18%. Other suitable values include about 3, 4, 5, 6, 7, 8, 9, 10, 11, 12, 13, 14, 15, 16, 17, 18, 19, 20, 21, 22, 23, 24, 25, 26, 27, 28, 29, 30%, and any range formed by a combination of these values.

For example, in embodiments in which the thermoplastic material is PET, the method in accordance with the disclosure using a reduced melt temperature can result in an about 3% to about 10% reduction in energy as compared to forming the molded article using a conventional injection molding process at a conventional melt temperature. For example, the reduction in energy can be about 5% to about 10%, about 8% to about 10%. Other suitable values include about 3, 4, 5, 6, 7, 8, 9, 10%and any range formed by a combination of these values.

For example, in embodiments in which the thermoplastic material is PP, the method in accordance with the disclosure using a reduced melt temperature can result in an about 3% to about 30%reduction in energy as compared to forming the molded article using a conventional injection molding process at a conventional melt temperature. For example, the reduction in energy can be about 3% to about 25%, about 10% to about 30%, about 10% to about 15%, about 15% to about 30%, about 12% to about 28%, and about 15% to about 25%. Other suitable values include about 3, 4, 5, 6, 7, 8, 9, 10, 11, 12, 13, 14, 15, 16, 17, 18, 19, 20, 21, 22, 23, 24, 25, 26, 27, 28, 29, 30%, and any range formed by a combination of these values.

For example, in embodiments in which the thermoplastic material is PS, the method in accordance with the disclosure using a reduced melt temperature can result in an about 3% to about 30% reduction in energy as compared to forming the molded article using a conventional injection molding process at a conventional melt temperature. For example, the reduction in energy can be about 3% to about 30%, about 5% to about 25%, about 10% to about 15%, about 15% to about 25%, about 10% to about 20%, and about 13% to about 27%. Other suitable values include about 3, 4, 5, 6, 7, 8, 9, 10, 11, 12, 13, 14, 15, 16, 17, 18, 19, 20, 21, 22, 23, 24, 25, 26, 27, 28, 29, 30%, and any range formed by a combination of these values.

For example, in embodiments in which the thermoplastic material is PMMA, the method in accordance with the disclosure using a reduced melt temperature can result in an about 3% to about 25% reduction in energy as compared to forming the molded article using a conventional injection molding process at a conventional melt temperature. For example, the reduction in energy can be about 3% to about 20%, about 10% to about 25%, about 10% to about 15%, about 15% to about 25%, about 10% to about 20%, and about 10% to about 24%. Other suitable values include about 3, 4, 5, 6, 7, 8, 9, 10, 11, 12, 13, 14, 15, 16, 17, 18, 19, 20, 21, 22, 23, 24, 25%, and any range formed by a combination of these values.

Embodiments of the method of the disclosure can also provide a power savings advantage over conventional injection molding processes using conventional melt temperatures. For example, in embodiments in which the thermoplastic material is ABS, the C/I index can be about 1.02 to about 1.16, about 1.1 to about 1.16, about 1.13 to about 1.16, about 1.12 to about 1.15, and about 1.14 to about 1.16. Other suitable values of the C/I index include about 1.02, 1.03, 1.04, 1.05, 1.06, 1.07, 1.08, 1.09, 1.1, 1.11, 1.12, 1.13, 1.14, 1.15, 1.16, and any range formed by the combination of these values.

For example, in embodiments in which the thermoplastic material is nylon 6, the C/I index can be about 1.02 to about 1.22, about 1.03 to about 1.22, about 1.13 to 1.22, about 1.13 to about 1.20, about 1.15 to about 1.20, and about 1.14 to about 1.17. Other suitable values of the C/I index include about 1.02, 1.028, 1.03, 1.04, 1.05, 1.06, 1.07, 1.08, 1.09, 1.1, 1.11, 1.12, 1.13, 1.14, 1.15, 1.16, 1.17, 1.18, 1.19, 1.20, 1.21, 1.22, and any range formed by the combination of these values.

For example, in embodiments in which the thermoplastic material is PC, the C/I index can be about 1.018 to about 1.23, about 1.02 to about 1.23, about 1.05 to about 1.2, about 1.07 to about 1.23, about 1.1 to about 1.2, about 1.15 to about 1.23, about 1.08 to about 1.23, and about 1.14 to about 1.23. Other suitable values include about 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, and any range formed by the combination of these values.

For example, in embodiments in which the thermoplastic material is HDPE, the C/I index can be about 1.02 to about 1.23, about 1.05 to about 1.23, about1.08 to about 1.23, about 1.1 to about 1.2, about 1.15 to about 1.23, about 1.12 to about 1.23, and about 1.14 to about 1.23. Other suitable values include about 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, and any range formed by the combination of these values.

For example, in embodiments in which the thermoplastic material is PET, the C/I index can be about 1.02 to about 1.10, about 1.04 to about 1.09, about 1.07 to about 1.10, about 1.08 to about 1.10, about 1.08 to about 1.09, and about 1.095 to about 1.098. Other suitable values include about 1.02, 1.03, 1.04, 1.05, 1.06, 1.07, 1.08, 1.085, 1.090, 1.095, 1.097, 1.10, and any range formed by the combination of these values.

For example, in embodiments in which the thermoplastic material is PP, the C/I index can be about 1.02 to about 1.3, about 1.022 to about 1.28, about 1.10 to about 1.3, about 1.1 to about 1.28, about 1.1 to about 1.29, about 1.15 to about 1.3, and about 1.10 to about 1.25. Other suitable values include about 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, 1.24, 1.25, 1.26, 1.27, 1.28, 1.29, 1.30, and any range formed by the combination of these values.

For example in embodiments in which the thermoplastic material is PS, the C/I index can be about 1.02 to about 1.17, about 1.04 to about 1.12, about 1.08 to about 1.17, about 1.09 to about 1.15, about 1.10 to about 1.17, and about 1.14 to about 1.17. Other suitable values include about 1.02, 1.03, 1.04, 1.05, 1.06, 1.07, 1.08, 1.09, 1.10, 1.11, 1.12, 1.13, 1.14, 1.15, 1.16, 1.17, and any range formed by the combination of these values.

For example, in embodiments in which the thermoplastic material is PMMA, the C/I index can be about 1.02 to about 1.23, about 1.022 to about 1.28, about 1.04 to about 1.13, about 1.09 to about 1.23, about 1.1 to about 1.2, about 1.15 to about 1.23, about 1.12 to about 1.23, and about 1.14 to about 1.23. Other suitable values include about 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, 1.21, 1.22, 1.23, and any range formed by the combination of these values.

By utilizing the embodiments of the method of the disclosure, the cycle time required to form the molded article may be reduced as compared to a conventional injection molding process using a conventional melt temperature and molding a molded article having the same dimensions. In general, the methods of the disclosure can provide cycle time reduction of about 5% to about 30%.

### EXAMPLE

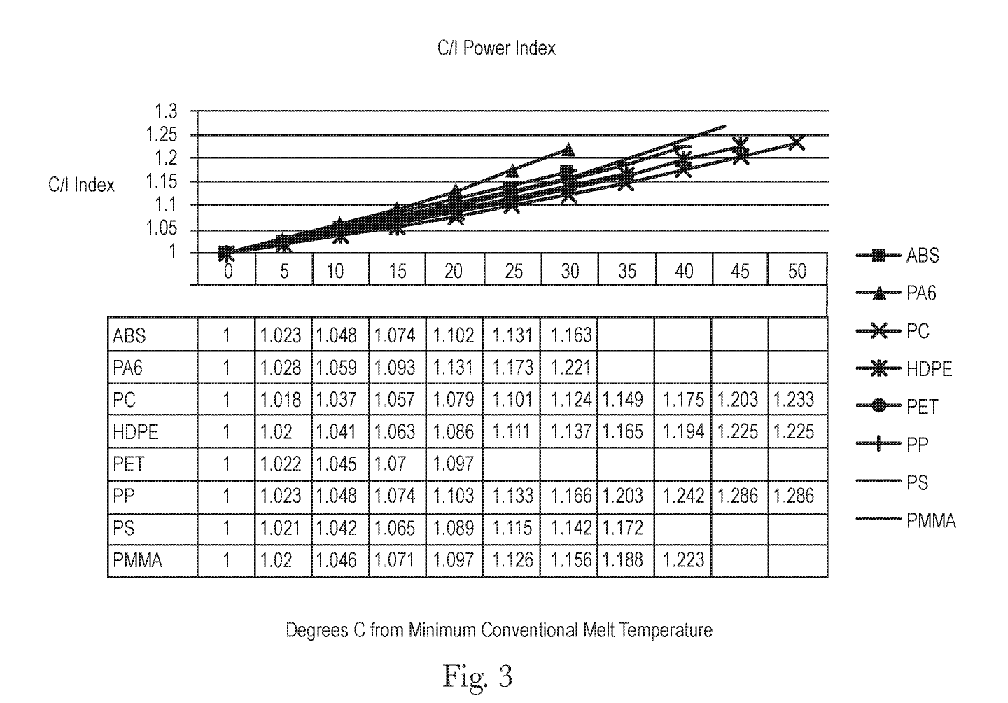

Turning to FIG. 3, a C/I Power Index graph 300 is provided. In the graph 300, the x-axis represents a difference between the conventional, industrial average (“C”) melt temperature and the improved (“I”) melt temperature. Accordingly, the initial temperature (e.g., “0”) represents a melt temperature equal to the industrial average value. The y-axis represents the C/I index value previously described. The higher the C/I Index for a given material, the more “efficient” it is to form, thus maximizing this ratio within material constraints is preferred.

FIG. 3 illustrates the C/I index of various materials as a function of decreasing the melt temperature. Point 0 represents the minimum conventional melt temperature reported for the commodity grades of these materials, as provided in Table 1, above.

So configured, molded articles formed via the improved injection molding process exhibit similar characteristics to those conventionally formed, yet require less energy input to be formed. As such, a “low-calorie” injection molding process is provided which requires less time and energy to complete. More parts may be formed in the same amount of time as conventional processes, thus increasing process efficiencies.

In various embodiments, the process 200 results in a molded part that is free of short shot or freeze-off. In other words, the molded part may be determined a quality part that is acceptable for its intended use. The thermoplastic material may be substantially free of rheology modifying additives or other additives affecting the melt temperature. It is understood, however, that rheology modifying additives may be used in some examples.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of forming a molded article using an injection molding apparatus, comprising:
heating a thermoplastic material to a reduced melt temperature;
injecting the heated thermoplastic material into at least one mold cavity of an injection molding apparatus, wherein the at least one mold cavity is filled at a substantially constant pressure; and
cooling the thermoplastic material in the at least one mold cavity to an ejection temperature to form the molded article, wherein:
the thermoplastic material is acrylonitrile butadiene styrene (ABS) and the reduced melt temperature is about 5° C. to about 30° C. less than a minimum conventional melt temperature of the ABS and an energy required to form the molded article is at least about 3% less than an energy required to form the molded article using a conventional injection molding process at the minimum conventional melt temperature, or
the thermoplastic material is nylon 6 and the reduced melt temperature is about 5° C. to about 30° C. less than a minimum conventional melt temperature of the nylon 6, and an energy required to form the molded article is at least about 3% less than an energy required to form the molded article using a conventional injection molding process at the minimum conventional melt temperature, or
the thermoplastic material is polycarbonate (PC) and the reduced melt temperature is about 5° C. to about 50° C. less than a minimum conventional melt temperature of the PC, and an energy required to form the molded article is at least about 3% less than an energy required to form the molded article using a conventional injection molding process at the minimum conventional melt temperature, or
the thermoplastic material is high density polyethylene (HDPE) and the reduced melt temperature is about 5° C. to about 45° C. less than a minimum conventional melt temperature of the HDPE, and an energy required to form the molded article is at least about 3% less than an energy required to form the molded article using a conventional injection molding process at the minimum conventional melt temperature, or
the thermoplastic material is polyethylene terephthalate (PET) and the reduced melt temperature is about 5° C. to about 20° C. less than a minimum conventional melt temperature of the PET, and an energy required to form the molded article is at least about 3% less than an energy required to form the molded article using a conventional injection molding process at the minimum conventional melt temperature, or
the thermoplastic material is polypropylene (PP) and the reduced melt temperature is about 5° C. to about 45° C. less than a minimum conventional melt temperature of the PP, and an energy required to form the molded article is at least about 3% less than an energy required to form the molded article using a conventional injection molding process at the minimum conventional melt temperature, or
the thermoplastic material is polystyrene (PS) and the reduced melt temperature is about 5° C. to about 35° C. less than a minimum conventional melt temperature of the PS, and an energy required to form the molded article is at least about 3% less than an energy required to form the molded article using a conventional injection molding process at the minimum conventional melt temperature, or
the thermoplastic material is poly(methyl methacrylate) (PMMA) and the reduced melt temperature is about 5° C. to about 40° C. less than a minimum conventional melt temperature of the PMMA, and an energy required to form the molded article is at least about 3% less than an energy required to form the molded article using a conventional injection molding process at the minimum conventional melt temperature.

2. The method of claim 1, wherein:
the thermoplastic material is acrylonitrile butadiene styrene (ABS) and the reduced melt temperature is about 20° C. to about 30° C. less than a minimum conventional melt temperature of the ABS and an energy required to form the molded article is at least about 10% less than an energy required to form the molded article using a conventional injection molding process at the minimum conventional melt temperature, or
the thermoplastic material is nylon 6 and the reduced melt temperature is about 20° C. to about 30° C. less than a minimum conventional melt temperature of the nylon 6, and an energy required to form the molded article is at least about 10% less than an energy required to form the molded article using a conventional injection molding process at the minimum conventional melt temperature, or
the thermoplastic material is polycarbonate (PC) and the reduced melt temperature is about 5° C. to about 50° C. less than a minimum conventional melt temperature of the PC, and an energy required to form the molded article is at least about 9% less than an energy required to form the molded article using a conventional injection molding process at the minimum conventional melt temperature, or
the thermoplastic material is high density polyethylene (HDPE) and the reduced melt temperature is about 20° C. to about 45° C. less than a minimum conventional melt temperature of the HDPE, and an energy required to form the molded article is at least about 10% less than an energy required to form the molded article using a conventional injection molding process at the minimum conventional melt temperature, or
the thermoplastic material is polyethylene terephthalate (PET) and the reduced melt temperature is about 20° C. to about 20° C. less than a minimum conventional melt temperature of the PET, and an energy required to form the molded article is at least about 10% less than an energy required to form the molded article using a conventional injection molding process at the minimum conventional melt temperature, or
the thermoplastic material is polypropylene (PP) and the reduced melt temperature is about 20° C. to about 45° C. less than a minimum conventional melt temperature of the PP, and an energy required to form the molded article is at least about 10% less than an energy required to form the molded article using a conventional injection molding process at the minimum conventional melt temperature, or
the thermoplastic material is polystyrene (PS) and the reduced melt temperature is about 20° C. to about 35° C. less than a minimum conventional melt temperature of the PS, and an energy required to form the molded article is at least about 10% less than an energy required to form the molded article using a conventional injection molding process at the minimum conventional melt temperature, or
the thermoplastic material is poly(methyl methacrylate) (PMMA) and the reduced melt temperature is about 20° C. to about 40° C. less than a minimum conventional melt temperature of the PMMA, and an energy required to form the molded article is at least about 10% less than an energy required to form the molded article using a conventional injection molding process at the minimum conventional melt temperature.

3. A method of forming a molded article using an injection molding apparatus, comprising:
heating a thermoplastic material to a reduced melt temperature;
injecting the heated thermoplastic material into at least one mold cavity of an injection molding apparatus, wherein the at least one mold cavity is filled at a substantially constant pressure; and
cooling the thermoplastic material in the at least one mold cavity to an ejection temperature to form the molded article, wherein:
the thermoplastic material is an acrylonitrile butadiene styrene (ABS) having a minimum conventional melt temperature of about 216° C., and the reduced melt temperature is about 185° C. to about 211° C., or
the thermoplastic material is a nylon 6 having a minimum conventional melt temperature of about 253° C. and the reduced melt temperature is about 220° C. to about 248° C., or
the thermoplastic material is a polycarbonate (PC) having a minimum conventional melt temperature of about 292° C. and the reduced melt temperature is about 240° C. to about 287° C., or
the thermoplastic material is a high density polyethylene (HDPE) having a minimum conventional melt temperature of about 216° C. and the reduced melt temperature is about 170° C. to about 211° C., or
the thermoplastic material is a polyethylene terephthalate (PET) having a minimum conventional melt temperature of about 250° C. and the reduced melt temperature is about 230° C. to about 245° C., or
the thermoplastic material is a polypropylene (PP) having a minimum conventional melt temperature of about 212° C. and the reduced melt temperature is about 162° C. to about 207° C., or
the thermoplastic material is a polystyrene (PS) having a minimum conventional melt temperature of about 185° C. and the reduced melt temperature is about 150° C. to about 180° C., or
the thermoplastic material is a poly(methyl methacrylate) (PMMA) having a minimum conventional melt temperature of about 227° C. and the reduced melt temperature is about 187° C. to about 222° C.

4. The method of claim 3, wherein an energy required to form the molded article is at least about 3% less than an energy required to form the molded article using a conventional injection molding process at the minimum conventional melt temperature.

5. The method of claim 3, wherein:
the thermoplastic material is the ABS having a minimum conventional melt temperature of about 216° C., and the reduced melt temperature is about 186° C. to about 196° C., or
the thermoplastic material is the nylon 6 having a minimum conventional melt temperature of about 253° C. and the reduced melt temperature is about 223° C. to about 23 3° C., or
the thermoplastic material is the polycarbonate (PC) having a minimum conventional melt temperature of about 292° C. and the reduced melt temperature is about 242° C. to about 272° C., or
the thermoplastic material is the high density polyethylene (HDPE) having a minimum conventional melt temperature of about 216° C. and the reduced melt temperature is about 170° C. to about 196° C., or
the thermoplastic material is the polyethylene terephthalate (PET) having a minimum conventional melt temperature of about 250° C. and the reduced melt temperature is about 230° C., or
the thermoplastic material is the polypropylene (PP) having a minimum conventional melt temperature of about 212° C. and the reduced melt temperature is about 167° C. to about 192° C., or
the thermoplastic material is the polystyrene (PS) having a minimum conventional melt temperature of about 185° C. and the reduced melt temperature is about 150° C. to about 165° C., or
the thermoplastic material is the poly(methyl methacrylate) (PMMA) having a minimum conventional melt temperature of about 227° C. and the reduced melt temperature is about 187° C. to about 207° C.

6. The method of claim 5, wherein an energy required to form the molded article is at least about 10% less than an energy required to form the molded article using a conventional injection molding process at the minimum conventional melt temperature

7. A method of forming a molded article using an injection molding apparatus, comprising:
heating a thermoplastic material to a reduced melt temperature, wherein the reduced melt temperature is at least 5° C. less than a minimum conventional melt temperature of the thermoplastic material;
injecting the heated thermoplastic material into at least one mold cavity of an injection molding apparatus, wherein the at least one mold cavity is filled at a substantially constant pressure; and
cooling the thermoplastic material in the at least one mold cavity to an ejection temperature to form the molded article, wherein:
the thermoplastic material is acrylonitrile butadiene styrene (ABS) and the molded article is formed at a power index is about 1.02 to about 1.16 when compared to forming the molded article using a conventional injection molding process at the minimum conventional melt temperature, or
the thermoplastic material is nylon 6 and the molded article is formed at a power index of about 1.02 to about 1.22 when compared to forming the molded article using a conventional injection molding process at the minimum conventional melt temperature, or
the thermoplastic material is polycarbonate (PC) and the molded article is formed at a power index of about 1.02 to about 1.23 when compared to forming the molded article using a conventional injection molding process at the minimum conventional melt temperature, or
the thermoplastic material is high density polyethylene (HDPE) and the molded article is formed at a power index of about 1.02 to about 1.23when compared to forming the molded article using a conventional injection molding process at the minimum conventional melt temperature, or
the thermoplastic material is polyethylene terephthalate (PET) and the molded article is formed at a power index of about 1.02 to about 1.10 when compared to forming the molded article using a conventional injection molding process at the minimum conventional melt temperature, or
the thermoplastic material is polypropylene (PP) and the molded article is formed at a power index of about 1.02 to about 1.30 when compared to forming the molded article using a conventional injection molding process at the minimum conventional melt temperature, or
the thermoplastic material is polystyrene (PS) and the molded article is formed at a power index of about 1.02 to about 1.17 when compared to forming the molded article using a conventional injection molding process at the minimum conventional melt temperature, or
the thermoplastic material is poly(methyl methacrylate) (PMMA) the molded article is formed at a power index of about 1.02 to about 1.23 when compared to forming the molded article using a conventional injection molding process at the minimum conventional melt temperature.

8. The method of claim 7, wherein:
the reduced melt temperature is at least 20° C. less than a minimum conventional melt temperature of the thermoplastic material, and
the thermoplastic material is acrylonitrile butadiene styrene (ABS) and the molded article is formed at a power index of about 1.1 to about 1.16 when compared to forming the molded article using a conventional injection molding process at the minimum conventional melt temperature, or
the thermoplastic material is nylon 6 and the molded article is formed at a power index of about 1.13 to about 1.22 when compared to forming the molded article using a conventional injection molding process at the minimum conventional melt temperature, or
the thermoplastic material is polycarbonate (PC) and the molded article is formed at a power index of about 1.07 to about 1.23 when compared to forming the molded article using a conventional injection molding process at the minimum conventional melt temperature, or
the thermoplastic material is high density polyethylene (HDPE) and the molded article is formed at a power index of about 1.08 to about 1.23when compared to forming the molded article using a conventional injection molding process at the minimum conventional melt temperature, or
the thermoplastic material is polyethylene terephthalate (PET) and the molded article is formed at a power index of about 1.08 to about 1.10 when compared to forming the molded article using a conventional injection molding process at the minimum conventional melt temperature, or
the thermoplastic material is polypropylene (PP) and the molded article is formed at a power index of about 1.10 to about 1.30 when compared to forming the molded article using a conventional injection molding process at the minimum conventional melt temperature, or
the thermoplastic material is polystyrene (PS) and the molded article is formed at a power index of about 1.08 to about 1.17 when compared to forming the molded article using a conventional injection molding process at the minimum conventional melt temperature, or
the thermoplastic material is poly(methyl methacrylate) (PMMA) the molded article is formed at a power index of about 1.09 to about 1.23 when compared to forming the molded article using a conventional injection molding process at the minimum conventional melt temperature

9. The method of claim 7, wherein:
the thermoplastic material is an acrylonitrile butadiene styrene (ABS) having a minimum conventional melt temperature of about 216° C., or
the thermoplastic material is a nylon 6 having a minimum conventional melt temperature of about 253° C., or
the thermoplastic material is a polycarbonate (PC) having a minimum conventional melt temperature of about 292° C., or
the thermoplastic material is a high density polyethylene (HDPE) having a minimum conventional melt temperature of about 216° C., or
the thermoplastic material is a polyethylene terephthalate (PET) having a minimum conventional melt temperature of about 250° C., or
the thermoplastic material is a polypropylene (PP) having a minimum conventional melt temperature of about 212° C., or
the thermoplastic material is a polystyrene (PS) having a minimum conventional melt temperature of about 185° C., or
the thermoplastic material is a poly(methyl methacrylate) (PMMA) having a minimum conventional melt temperature of about 227° C.

10. The method of claim 7, wherein the method is free of short shot or freeze-off.

11. The method of claim 7, wherein the thermoplastic material is substantially free of rheology modifying additives.

12. The method of claim 7, wherein the at least one mold cavity is filled at a substantially constant pressure of 400 to 35000.

13. The method of any one of claim 12, wherein the at least one mold cavity is filled at a substantially constant pressure of 400 to 6000.

14. The method of claim 7, wherein a cycle time to form the molded article is at least 5% less than a cycle time to form the molded article using a conventional injection molding process.

15. The method of claim 14, wherein the cycle time to form the molded article is about 5% to about 30% less than a cycle time to form the molded article using a conventional injection molding process at the minimum conventional melt temperature.
